(19) United States
(12) Patent Application Publication
(10) Pub. No.: US 2025/0080950 A1
(43) Pub. Date: Mar. 6, 2025

(54) ELECTRONIC DEVICE AND PROCESSING METHOD FOR LOCATING WIRELESS SIGNALS THEREOF

(71) Applicant: ASUSTeK COMPUTER INC., Taipei (TW)

(72) Inventors: Yu-Chih HUNG, Taipei (TW); Chi-Chung LIU, Taipei (TW); Chi-Chien TUNG, Taipei (TW); May SU, Taipei (TW)

(21) Appl. No.: 18/775,384

(22) Filed: Jul. 17, 2024

(30) Foreign Application Priority Data
Sep. 1, 2023 (TW) 112133387

(51) Int. Cl. H04W 4/029

(52) U.S. Cl. CPC H04W 4/029

(57) ABSTRACT

An electronic device and a processing method for locating wireless signals are provided here. The electronic device for locating wireless signals comprises: a plurality of antenna units, providing a plurality of antenna patterns; a switching control circuit, connected to the antenna units, wherein the switching control circuit is selectively electrically connected to at least one of the antenna units, so as to select one of the antenna patterns correspondingly; a communication module, electrically connected to the switching control circuit; and a processing circuit, electrically connected to the switching control circuit and the communication module and configured to control the switching control circuit to be electrically connected to the communication module and at least one of the antenna units.

### CROSS-REFERENCE TO RELATED APPLICATION

This application claims the priority benefit of Taiwan application serial No. 112133387, filed on Sep. 1, 2023. The entirety of the above-mentioned patent application is hereby incorporated by reference herein and made a part of the specification.

### BACKGROUND OF THE INVENTION

### Field of the Invention

The disclosure relates to an electronic device and a processing method for locating wireless signals, to determine a direction using a prediction model.

### Description of the Related Art

In a general wireless fidelity (WI-FI) environment, when a WI-FI signal sent by an access point (AP) in an ambient environment is to be located, distance estimation and location determining are performed based on a received signal strength indication (RSSI). Due to refraction, diffraction, and the like of an electromagnetic wave, there is much room for improvement of this method in accuracy.

In particular, a conventional approach is locating with a single fixed antenna pattern based on the received signal strength indication, which is prone to multipath propagation and the like formed by the conduction characteristic of the electromagnetic wave, resulting in data errors, which in turn affects the accuracy of locating. On the other hand, in the conventional approach, it may also use the received signal strength indication to construct a database to divide a space to be located is into many sub-spaces, and collect a signal feature of each small space to establish a signal map. During a connection phase, a signal feature received during locating will be compared with the signal map in the database to find locating coordinates. However, this approach takes a lot of time and manpower to construct the database and maintain and re-train the signal map.

### BRIEF SUMMARY OF THE INVENTION

The disclosure provides an electronic device for locating wireless signals, including a plurality of antenna units, a switching control circuit, a communication module, and a processing circuit. The antenna units provide a plurality of antenna patterns. The switching control circuit is connected to the antenna units. The switching control circuit is selectively electrically connected to at least one of the antenna units, so as to select one of the antenna patterns correspondingly. The communication module is electrically connected to the switching control circuit. The processing circuit is electrically connected to the switching control circuit and the communication module, and is configured to control the switching control circuit to be electrically connected to the communication module and at least one of the antenna units. The processing circuit controls the switching control circuit to switch connections of the communication module to the antenna units in sequence to collect beacon broadcast information corresponding to a plurality of access points for each antenna pattern. The processing circuit establishes a prediction model based on each antenna pattern and the corresponding beacon broadcast information at each access point, and divides the antenna patterns into a plurality of directional regions, so that the processing circuit obtains the beacon broadcast information in a current environment and selects, through the prediction model, at least one antenna pattern in one of the directional regions for locating.

The disclosure further provides a processing method for locating wireless signals, applicable to an electronic device. The processing method includes: selectively switching a plurality of antenna units in the electronic device, and correspondingly selecting one of a plurality of antenna patterns in a current environment, so as to obtain beacon broadcast information corresponding to a plurality of access points for each antenna pattern; inputting the beacon broadcast information to a prediction model, so as to determine, based on the prediction model, a directional region corresponding to the beacon broadcast information; using at least one antenna pattern in the directional region for locating; and finally determining whether all the access points have significant relative movements or disappear, and when the access points have significant relative movements or disappear, reestablishing the prediction model.

In summary, the disclosure provides the electronic device for locating wireless signals. The plurality of antenna patterns is used to establish the prediction model by a machine learning algorithm, and the prediction model is used to select the antenna pattern in a corresponding directional region for locating. In this way, the accuracy and efficiency are improved, an error that may be caused by selecting an inappropriate antenna pattern is avoided, and costs in operation and maintenance are reduced. Furthermore, in the disclosure, the prediction model enhances the determining of a movement status, so as to improve the locating accuracy.

### BRIEF DESCRIPTION OF THE DRAWINGS

FIG. 1 is a schematic block diagram of a circuit of an electronic device for locating wireless signals according to an embodiment of the disclosure;

FIG. 2 is a schematic flowchart of establishing a prediction model by an electronic device according to an embodiment of the disclosure; and

FIG. 3 is a schematic flowchart of a processing method for locating wireless signals according to an embodiment of the disclosure.

### DETAILED DESCRIPTION OF THE EMBODIMENTS

The following describes embodiments of the disclosure with reference to related drawings. In addition, some elements or structures are omitted in the drawings in the embodiments to clearly present technical features of the disclosure. The same reference numbers in these drawings represent the same or similar elements or circuits. It is to be understood that terms “first”, “second”, and the like are used herein to describe various elements, components, regions, or functions, but these elements, components, regions, and/or functions are not limited to these terms, and the terms are used only to distinguish between one element, component, region, or function from another element, component, region, or function.

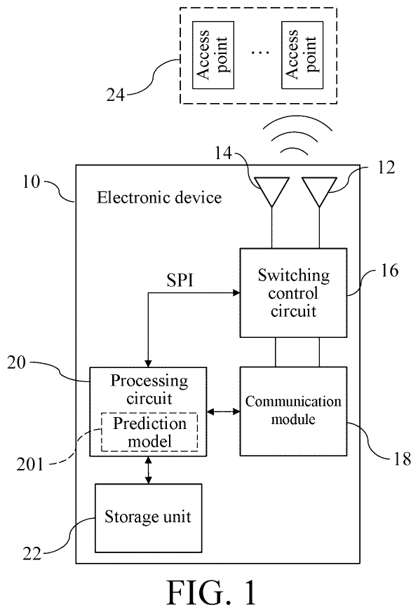

Referring to FIG. 1, an electronic device 10 for locating wireless signals includes a plurality of antenna units (a first antenna unit 12 and a second antenna unit 14), a switching control circuit 16, a communication module 18, a processing circuit 20, and a storage unit 22. In the electronic device 10 for locating wireless signals, the first antenna unit 12 and the second antenna unit 14 provide a plurality of antenna patterns. In an embodiment, FIG. 1 uses the electronic device 10 including the first antenna unit 12 and the second antenna unit 14 as an example. However, the disclosure is not limited thereto. When the electronic device 10 includes the first antenna unit 12 and the second antenna unit 14 that form a 2*2 multiple-input multiple-output (MIMO) antenna system, the first antenna unit 12 and the second antenna unit 14 are combined to provide 16 antenna patterns in total. The switching control circuit 16 is connected to the first antenna unit 12 and the second antenna unit 14. The switching control circuit 16 is selectively electrically connected to at least one of the first antenna unit 12 and the second antenna unit 14, which is used as an antenna unit for current communication, so as to select one of the antenna patterns correspondingly. The communication module 18 is electrically connected to the switching control circuit 16. The processing circuit 20 is electrically connected to the switching control circuit 16 and the communication module 18, and is configured to control the switching control circuit 16 to be electrically connected to the communication module 18 and at least one of the first antenna unit 12 and the second antenna unit 14. The processing circuit 20 is connected to the switching control circuit 16 through a serial peripheral interface (SPI), so as to transmit a control signal to the switching control circuit 16 through the SPI.

Furthermore, a machine learning algorithm is built in the processing circuit 20. The machine learning algorithm is used to analyze and predict feature values such as a service set identifier, a media access control address, received signal strength indication, and channel state information in beacon broadcast information, and determine distribution of all the antenna patterns in the electronic device 10, whether the electronic device 10 moves and a movement direction, and a direction, a distance, and a movement direction of an individual signal of an access point relative to the electronic device 10.

Continue to refer to FIG. 1. The electronic device 10 includes a plurality of access points (APs) 24 within a communication range. The processing circuit 20 controls the switching control circuit 16 to switch connections of the communication module 18 in sequence to the first antenna unit 12 and the second antenna unit 14, so that the communication module 18 is connected in turn to all combinations of the first antenna unit 12 and the second antenna unit 14 through the switching control circuit 16, so as to collect beacon broadcast information at all the access points 24 within the communication range for each antenna pattern. The beacon broadcast information includes a service set identifier (SSID), a media access control (MAC) address, and a received signal strength indication (RSSI) that correspond to the access point. A larger value of the received signal strength indication indicates a higher received signal strength and higher communication quality. Furthermore, in addition to the service set identifier, the media access control address, and the received signal strength indication, the beacon broadcast information further includes channel state information (CSI), to improve the locating accuracy. Therefore, when data is collected, channel state information corresponding to each antenna pattern is also collected. After all beacon broadcast information within the communication range is collected, the processing circuit 20 establishes a prediction model 201 based on each antenna pattern and the corresponding beacon broadcast information at each access point 24 by a machine learning algorithm, and divides the antenna patterns into a plurality of directional regions. In an embodiment, the antenna patterns are divided into four quadrant regions with the electronic device 10 as a center, so that the processing circuit 20 obtains the beacon broadcast information in a current environment and selects, through the prediction model 201, at least one antenna pattern in one of the directional regions for locating, to transmit or track a wireless signal (WI-FI signal). In other words, the prediction model 201 identifies, based on the beacon broadcast information obtained in the current environment, which access point 24 falls in which directional region, and finally selects, based on one access point 24 to be used, at least one antenna pattern in the corresponding directional region for locating.

As shown in FIG. 1, the processing circuit 20 is electrically connected to the storage unit 22. The storage unit 22 is used as a database, so that the processing circuit 20 stores data such as all the antenna patterns and the corresponding beacon broadcast information (including the service set identifier, the media access control address, the received signal strength indication, and the channel state information) at each access point 24 in the storage unit 22, and obtains data related to a training operation from the storage unit 22 when the training operation is performed to establish the prediction model 201. In an embodiment, the storage unit 22 is a repeatedly readable/writable non-transitory memory, such as a flash memory, a solid state disk, or a microdrive. However, the disclosure is not limited thereto.

In an embodiment, the electronic device 10 is a notebook computer, a tablet computer, a smartphone, or the like. However, the disclosure is not limited thereto.

In an embodiment, the switching control circuit 16 is a mixed-mode hardware circuit with radio frequency and intermediate frequency control and direct current power. The switching control circuit 16 further includes a plurality of switching elements (not shown), so that the first antenna unit 12 and the second antenna unit 14 are coupled to the communication module 18 through the switching elements, to form a plurality of antenna combinations to provide a corresponding number of antenna patterns. Therefore, the processing circuit 20 selectively controls the switching element in the switching control circuit 16 to be turned on. That is, the switching element is turned on to connect the communication module 18 to at least one of the first antenna unit 12 and the second antenna unit 14, to receive the beacon broadcast information periodically sent from all the access points 24. However, the disclosure is not limited thereto.

In an embodiment, the communication module 18 includes a circuit element supporting communication transmission, such as a data machine and a radio frequency front-end transceiver circuit, to support a wireless communication technology WI-FI.

In an embodiment, the processing circuit 20 is but is not limited to a central processing unit (CPU), an embedded controller (EC), a microprocessor, a digital signal processor (DSP), an application-specific integrated circuit (ASIC), a system on a chip (SOC) or another similar element, or a combination thereof. However, the disclosure is not limited thereto.

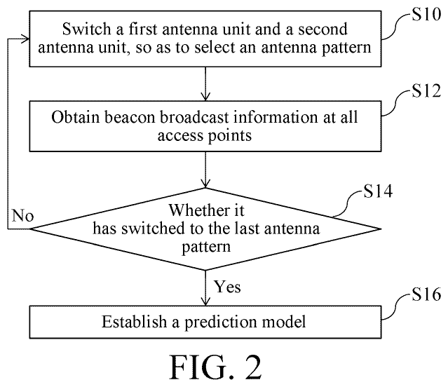

Referring to FIG. 1 and FIG. 2, in the electronic device 10, a detailed process in which the processing circuit 20 establishes the prediction model 201 includes step S10 to step S16. First, as shown in step S10, the processing circuit 20 controls the switching control circuit 16 to switch the connection of the communication module 18 to the first antenna unit 12 or the second antenna unit 14 selected, so as to select one antenna pattern. Then, as shown in step S12, the processing circuit 20 obtains, through the first antenna unit 12 or the second antenna unit 14 currently used, the beacon broadcast information at all the access points within the communication range, and stores the beacon broadcast information in the storage unit 22. As shown in step S14, the processing circuit 20 determines whether it has switched to the last antenna pattern. When the processing circuit 20 determines that it is not the last antenna pattern, step S10 is performed again, and the processing circuit 20 continues to control the switching control circuit 16 to switch the connection of the communication module 18 to a next group of first antenna units 12 or second antenna units 14, so as to select a next antenna pattern to continue to collect the beacon broadcast information. When the processing circuit 20 determines that it has switched to the last antenna pattern, step S16 continues to be performed. As shown in step S16, the processing circuit 20 establishes the prediction model 201 based on each antenna pattern and the corresponding beacon broadcast information at each access point 24, and divides all the antenna patterns into the plurality of directional regions in the prediction model 201.

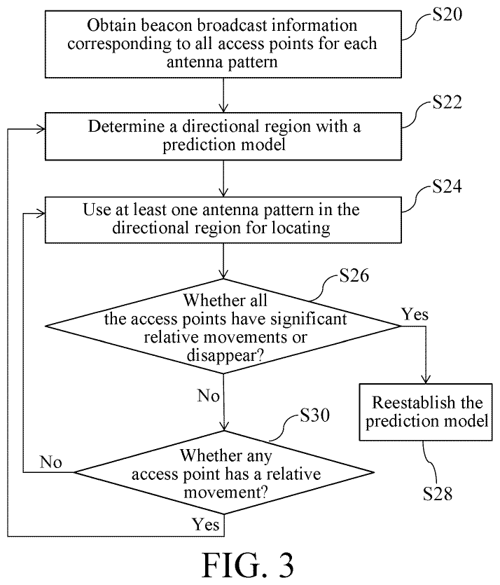

Referring to FIG. 1 and FIG. 3, a detailed process of a processing method for locating wireless signals include step S20 to step S30. The processing method is applicable to the electronic device 10. The electronic device 10 performs the processing method, including the following steps. As shown in step S20, the processing circuit 20 controls the switching control circuit 16 to selectively switch a connection of the communication module 18 to the first antenna unit 12 or the second antenna unit 14, and correspondingly selects one of a plurality of antenna patterns in a current environment, so as to obtain beacon broadcast information corresponding to the plurality of access points 24 for each antenna pattern. As shown in step S22, the beacon broadcast information obtained is input to the prediction model 201, so as to determine, based on the prediction model 201, a directional region corresponding to the beacon broadcast information, for example, four quadrant regions. After the corresponding directional region is obtained, as shown in step S24, at least one antenna pattern in the directional region is used for locating. If there is only one antenna pattern in the directional region, the antenna pattern is directly used; or if there are two antenna patterns in the directional region, the two antenna patterns are used. Therefore, only the antenna pattern in one directional region needs to be used to transmit or track a wireless signal (WI-FI signal). As shown in step S26, the processing circuit 20 determines whether all the access points 24 have significant relative movements (if the access points 24 do not move but the electronic device 10 moves, it means that the access points 24 move relative to the electronic device 10) or disappear. When all the access points 24 have significant relative movements or disappear, it indicates that the current environment in which the electronic device 10 is located changes, and as shown in step S28, the processing circuit 20 re-establishes the prediction model 201. When all the access points 24 have no significant relative movements or do not disappear, it indicates that the current environment in which the electronic device 10 does not change, and next step S30 continues to be performed. As shown in step S30, when all the access points 24 have no significant relative movements or do not disappear, whether any one of the access points 24 has a relative movement is further determined. If so, step S22 is performed again to redetermine the directional region based on the prediction model 201; or if not, step S24 is performed again to continue to use the antenna pattern in the directional region for locating.

According to the disclosure, the algorithm built in the processing circuit 20 switches all the antenna patterns to collect signal information such as the beacon broadcast information continuously sent from each access point 24, establishes the prediction model 201 through machine learning, and divides each antenna pattern formed by the first antenna unit 12 and the second antenna unit 14 into the plurality of directional regions (four quadrants). Therefore, in the disclosure, in a connection phase, a grouping result of the directional regions is combined with a size of a signal in the current environment to infer, through the prediction model 201, a direction, a distance, or a movement status of each WI-FI signal. Then, only the antenna pattern in one of the directional regions needs to be used for locating a WI-FI signal at a specific access point, to help transmit or track the WI-FI signal. Therefore, transmission or tracking with an antenna pattern closest to the access point can obtain an accurate determining result and reduce maintenance costs.

In summary, the disclosure provides the electronic device for locating wireless signals. The plurality of antenna patterns is used to establish the prediction model by the machine learning algorithm, and the prediction model is used to select the antenna pattern in a corresponding directional region for locating. In this way, the accuracy and efficiency are improved, an error that may be caused by selecting an inappropriate antenna pattern is avoided, and costs in operation and maintenance are reduced. In the disclosure, the directional regions are grouped and determined before connection rather than determined after the antenna pattern is switched, so that the impact on efficiency is avoided in the switching process. Furthermore, in the disclosure, the prediction model enhances the determining of the movement status, so as to improve the locating accuracy.

The foregoing embodiments are only to illustrate the technical idea and characteristics of the disclosure, for a purpose of enabling a person skilled in the art to understand the content of the disclosure and implement the disclosure accordingly, and do not limit the patent scope of the disclosure. That is, equivalent variations or modifications made according to the spirit disclosed in the disclosure should still be included in the patent scope of the disclosure.

What is claimed is:

1. An electronic device for locating wireless signals, comprising:
a plurality of antenna units, providing a plurality of antenna patterns;
a switching control circuit, connected to the antenna units, wherein the switching control circuit is selectively electrically connected to at least one of the antenna units, so as to select one of the antenna patterns correspondingly;
a communication module, electrically connected to the switching control circuit; and
a processing circuit, electrically connected to the switching control circuit and the communication module and configured to control the switching control circuit to be electrically connected to the communication module and at least one of the antenna units, wherein the processing circuit controls the switching control circuit to switch connections of the communication module to the antenna units in sequence to collect beacon broadcast information corresponding to a plurality of access points for each of the antenna patterns, and the processing circuit establishes a prediction model based on each of the antenna patterns and the beacon broadcast information corresponding to each of the access points, and divides the antenna patterns into a plurality of directional regions, so that the processing circuit obtains the beacon broadcast information in a current environment and selects, through the prediction model, at least one of the antenna patterns in one of the directional regions for locating.

2. The electronic device for locating wireless signals according to claim 1, wherein the prediction model identifies, based on the beacon broadcast information in the current environment, which access point falls in which directional region, and selects, based on one access point to be used, at least one of the antenna patterns in the corresponding directional region for locating.

3. The electronic device for locating wireless signals according to claim 1, wherein the beacon broadcast information comprises a service set identifier (SSID), a media access control (MAC) address, and a received signal strength indication (RSSI) that correspond to the access point.

4. The electronic device for locating wireless signals according to claim 3, wherein the beacon broadcast information further comprises channel state information (CSI).

5. The electronic device for locating wireless signals according to claim 1, wherein the directional regions are four quadrant regions divided with the electronic device as a center.

6. The electronic device for locating wireless signals according to claim 1, wherein the communication module performs locating through at least one of the antenna pattern in the directional region, so as to transmit or track a wireless signal.

7. The electronic device for locating wireless signals according to claim 1, further comprising a storage unit electrically connected to the processing circuit to store all the antenna patterns and the corresponding beacon broadcast information at each of the access points.

8. The electronic device for locating wireless signals according to claim 1, wherein the processing circuit is further connected to the switching control circuit through a serial peripheral interface.

9. A processing method for locating wireless signals, applicable to an electronic device, the processing method comprising:
selectively switching a plurality of antenna units in the electronic device, and correspondingly selecting one of a plurality of antenna patterns in a current environment, so as to obtain beacon broadcast information corresponding to a plurality of access points for each of the antenna patterns;
inputting the beacon broadcast information to a prediction model, so as to determine, based on the prediction model, a directional region corresponding to the beacon broadcast information;
using at least one of the antenna patterns in the directional region for locating; and
determining whether the access points have significant relative movements or disappear, and when the access points have significant relative movements or disappear, reestablishing the prediction model.

10. The processing method for locating wireless signals according to claim 9, wherein the prediction model identifies, based on the beacon broadcast information in the current environment, which access point falls in which directional region, and selects, based on one access point to be used, at least one of the antenna patterns in the corresponding directional region for locating.

11. The processing method for locating wireless signals according to claim 9, wherein the beacon broadcast information comprises a service set identifier (SSID), a media access control (MAC) address, and a received signal strength indication (RSSI) that correspond to the access point.

12. The processing method for locating wireless signals according to claim 11, wherein the beacon broadcast information further comprises channel state information (CSI).

13. The processing method for locating wireless signals according to claim 9, wherein the directional regions are four quadrant regions divided with the electronic device as a center.

14. The processing method for locating wireless signals according to claim 9, wherein a communication module in the electronic device performs locating through at least one of the antenna patterns in the directional region, so as to transmit or track a wireless signal.

15. The processing method for locating wireless signals according to claim 9, wherein in the step of determining whether the access points have significant relative movements or disappear, when the access points have no significant relative movements or do not disappear, whether one of the access points has a relative movement is further determined, and if so, the directional region is redetermined based on the prediction model, or if not, at least one of the antenna patterns in the directional region continues to be used for locating.
